(19) United States
(12) Patent Application Publication
(10) Pub. No.: US 2005/0068944 A1
(43) Pub. Date: Mar. 31, 2005

(54) Multimedia video telephony

(76) Inventor: Helmut Schmidt, Regensburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/931,345

(22) Filed: Sep. 1, 2004

(30) Foreign Application Priority Data
Feb. 9, 2003 (EP) 03019920.2

(51) Int. Cl. H04L 12/66

(52) U.S. Cl. 370/352

(57) ABSTRACT

Two connections are set up. The first one serves to transmit voice information and is controlled by a connection controller routed signaling H.225_{A}, BICC*, H.225_{B}. The second one serves to transmit image information and is controlled by a direct end point routed signaling H.245. Therefore, the services of the network PSTN can also be offered in full to the video telephony in an advantageous manner.

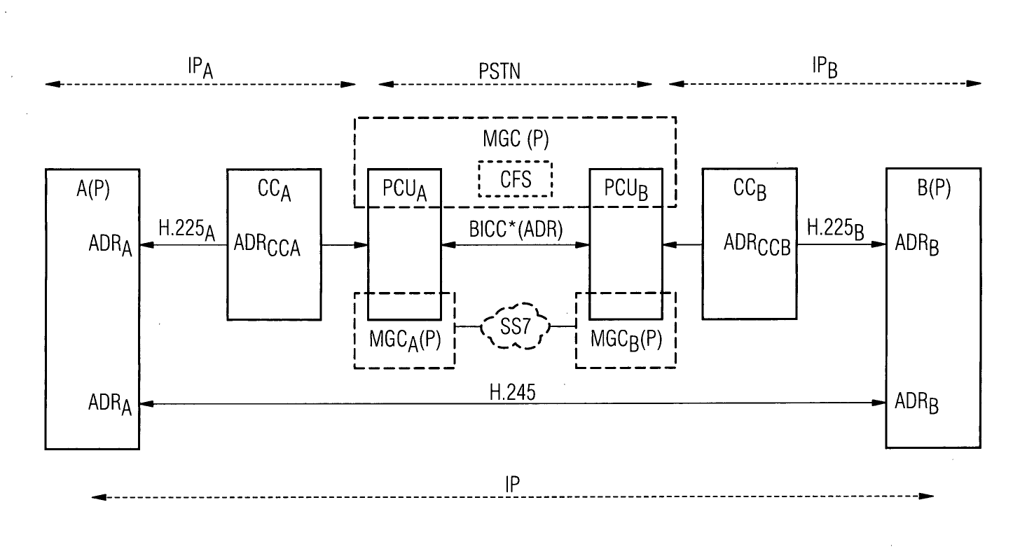

### CROSS REFERENCE TO RELATED APPLICATIONS

This application claims priority to the European application No. 03019920.2, filed Sep. 2, 2003 and which is incorporated by reference herein in its entirety.

### FIELD OF INVENTION

The invention relates to a method, device, and arrangement regarding multimedia video telephony.

### BACKGROUND OF INVENTION

In the past, two essential types of communication networks for transmitting information have been developed: Packet-oriented (data) networks and line-oriented (voice) networks. In the course of convergence of these two network types, convergent multimedia networks have been developed. The integration of these different network types creates hybrid networks.

### SUMMARY OF INVENTION

Line-oriented networks—also referred to as voice networks, telephone networks or public switched telephone networks (PSTN) are designed for transmitting continuously flowing (voice) information, known in professional circles as a (voice) connection or a call. In this case, information is usually transmitted with a high quality of service and security. For example, a minimum delay of <200 ms for example without fluctuations is required for voice, said voice requiring a continuous flow of information when it is reproduced in the receiver. Therefore, a loss of information cannot be compensated for by a repeated transmission of non-transmitted information and usually leads to acoustically perceptible interference (e.g. cracking, distortion, echo, silence) in the receiver. In professional circles, the transmission of voice is also generalized as a real-time (transmission) service and a real-time service.

Packet-oriented networks—also referred to as data networks—are also designed to transmit packet flows, known in professional circles as data packet flows, sessions or flows. In this case, a high quality of service need usually not be guaranteed. Without a guaranteed quality of service, the data packet flows are transmitted for example with temporary fluctuations because the individual data packets of the data packet flows are usually transmitted in the sequence of their network access, in other words, the more packets to be transmitted from a data network, the larger the temporal delays. Therefore, in professional circles, the transmission of data is also referred to as a transmission service without real-time conditions or as a non-real-time service.

The packets are usually distinguished depending on the type of packet-oriented network. They can for example be developed as the Internet, X.25 or frame relay packets, but also as ATM cells. They are also occasionally referred to as messages, particularly if a message is transmitted in a packet.

A well-known data network is the Internet. As a result, because of the Internet protocol IP used there, this is occasionally also referred to as the IP network in which case this term must basically be understood in its broader sense and includes all the networks that use the IP protocol. The Internet is embodied as an open (wide area) data network with open interfaces to connect (mostly locally and regionally) the data networks of different manufacturers. It makes available a transport platform that does not depend on the manufacturer.

Connections are communication relations between at least two subscribers for the purpose of a—mostly mutual, i.e. bi-directional-information transmission. The subscriber initiating the connection is usually referred to as the ‘A-subscriber’. A subscriber connected to an A-subscriber by the connection, is called a ‘B-subscriber’. In a connectionless network, connections represent at least the unambiguous relation between an A-subscriber and a B-subscriber on a logically abstract plane, i.e. according to this point of view, the connectionless flows in the Internet for example represent logically abstracted connections (e.g. A-subscriber=Browser and B-subscriber=Web Server). In a connection-oriented network, connections on a physical plane also represent unambiguous paths through the network along which the information is transmitted.

Signaling is only used to coordinate network components among each other, but not for the “actual” transmission of information in the above sense. The information transmitted for the signaling is usually referred to as signaling information, signaling data or plainly as signaling. However, the term must be understood in its broader sense. In this manner, the messages for controlling the registration, admission and status (RAS), the messages for controlling the useful channels of existing calls (e.g. according to the standard H.245) as well as all the other messages embodied in a similar way are also for example included. In order to distinguish the “actual information” from the signaling it is also called useful information, payload, media information, media data or plainly media. Communication relations that serve to transmit the signaling are in essence also termed as signaling connections. The communication relations used to transmit the useful information are for example called voice connection, useful channel connection or—in a simplified manner—useful channel, bearer channel or, in simpler terms, bearer.

In this context out-of-band or outband means the transmission of information to another path/medium other than that provided in the communication network for the transmission of signaling and useful information. In particular a local configuration of devices on site is included here which is, for examples effected using a local control unit. On the other hand, in the case of inband, information is transmitted along the same path/medium and, if required, separated logically from the considered signaling and useful information.

In the course of combining voice and data networks, voice transmission services and increasingly also broader band services such as the transmission of moving image information are similarly implemented in packet-oriented networks, i.e. the real-time services previously usually transmitted line-oriented are transmitted packet-oriented, i.e. the transmission of the hitherto conventional line-oriented transmitted real-time services takes place in a convergent network, packet-oriented, also referred to as a voice data network or a multimedia network, in other words in data flows. These are also known as real-time packet flows. Therefore, the transmission of voice information via a packet-oriented IP network is then also characterized with ‘VoIP’ (voice over IP).

The international standardization bodies IETF (Internet Engineering Task Force) and ITU (International Telecommunications Union) describe several distributed architectures for multimedia networks that initially assume homogenous multimedia networks.

In the case of ITU, the accompanying basic standard H.323 defines the transport of voice, data and video flows via an IP network. Audio and video flows are then transmitted according to the protocol RTP/RTCP. The connection control, amongst others, results from the protocol H.225 which enables the signaling, registering and synchronizing of media flows. The H.323 architecture primarily provides the following types of functional units:

Terminal, for example a terminal in a local area network (LAN) for the bi-directional real-time communication with other terminals,

Gatekeeper for carrying out the connection control,

Media gateway (MG) at the interface to other networks for the conversion of H.323 formats to the formats of these networks,

Media gateway controller (MGC) for controlling media gateways, in particular those connections transmitted in each case by using the protocol H.248 as well as for converting between different signaling protocols.

In the case of IETF, the telephony is standardized via the Internet in the session initiation protocol (SIP) by means of which interactive connections can be provided via the Internet. SIP supports the control of connections and the translation of SIP addresses to IP addresses. SIP is comparatively based on intelligent terminals by means of which signaling functions generate themselves. If a connection is set up by means of SIP, a description of the bearer is usually exchanged between the two sides of the connection. In addition the session description protocol (SDP) is used according to the standard RFC2327. This application is described, amongst others, in the standard RFC3264: “An Offer/Answer Model with the Session Description Protocol (SDP)”. The following bearer data is of particular importance:

IP address of the bearer connection

RTP/UDP port of the bearer connection (depending on whether or not there is a voice or data transmission)

Codec(s) that is/are (can be) used for voice or data transmission

Stream mode of the bearer connection

In the case of a connection setup, an SIP proxy server can be used, for example, if the end points that are interconnected do not know one another. It can also be configured such that it can evaluate, change and/or forward a request received for a client (e.g. an IP telephone, a PC or a PDA). MG and MGC are also provided at the interface to other networks. In order to control the MG, the protocol MGCP (media gateway control protocol) is used.

It is common for both architectures that the connection control plane and the resource control plane are functionally separated from one another in a clear manner and are mostly even implemented on different hardware platforms.

The connection control plane is used for the regulated activation and deactivation of network services. It can additionally include dedicated connection controllers to which the following functions can be assigned:

Address translation: Translation of E.164 telephone numbers and other alias addresses (e.g. computer names) to transport addresses (e.g. Internet addresses).

Admission control: Testing whether or not and/or in which scope, a utilization of the communication network is permitted.

Alias address modification: Returning a modified alias address that is used for example by the end points for a connection setup.

Bandwidth control: Managing transmission capacities, e.g. by controlling the permissible number of devices that may use the communication network at the same time.

Connection authorization: Validity check for incoming and outgoing connection requests.

Connection control signaling: Switching and/or processing signaling messages.

Connection management: Managing existing connections.

Dialed digit translation: Translating the dialed digits in an E.164 telephone number or a number from a private numbering scheme.

Zone management: Registering (e.g. VoIP-capable) devices and providing the above-mentioned functions to all the devices registered in the connection controller.

The resource control plane is used for the regulated realization of activated services. In order to control the network resources (e.g. transmission nodes) it can include a resource controller to which the following functions can be assigned:

Capacity control: Controlling the traffic volume fed to the communication network, e.g. by controlling and, if required, limiting the permissible transmission capacity of individual packet flows.

Policy activation: Reserving (transmission) resources in the communication network.

Priority management: Preferred transmission of prior traffic flows, e.g. by means of priority characteristics that are provided in prior packets.

Examples of the connection controller are represented by the gatekeeper from the ITU or the SIP proxy in the H.323. If a larger communication network is structured in several domains—also called ‘zones’—, a separate connection controller can be provided in each domain. A domain can also be operated without a connection controller. Should several connection controllers be provided in a domain, only one of these should be activated. From a logical point of view, a connection controller should be seen separately from the devices. However, it must not be implemented physically in a separate connection controller device, but can also be provided in each end point of a connection (for example embodied as H.323 or SIP terminal, media gateway, multipoint control unit) or also in a device embodied primarily for the program-controlled data processing (for example: computer, PC, server). A physically distributed implementation is also possible.

An alternative example of a connection controller is a media gateway controller to which the optional functions connection control signaling and connection management are usually assigned. Furthermore, the assignment of a signaling conversion function for converting different (signaling) protocols is also conceivable which can be required for example on the boundary between two different networks, which are integrated into one hybrid network.

The resource controller is also referred to as a ‘policy decision point (PDP)’. For example, it is implemented within so-called edge routers—also known as edge device, access node or when assigning to an Internet service provider (ISP) also called the provider edge router (PER). These edge routers can also be embodied as media gateways to other networks to which the multimedia networks are connected. These media gateways are then connected to both a multimedia network and other networks and serve internally the conversion between the different (transmission) protocols of the different networks. The resource controller can also only be embodied as the proxy and redirect resource controller-relevant information to a separate device on which the relevant information is processed according to a function of the resource controller.

Signaling messages are exchanged in these networks either by switching via a connection controller (call controller routed signaling—CCRS) or directly between the terminals (direct endpoint routed signaling—DERS). The variant used can be specified individually per connection for each terminal and each transmission.

In the case of CCRS, all the signaling messages of at least one call controller are transmitted. All the devices only send and receive signaling messages via the call controller. Therefore, a direct exchange of signaling messages between the devices is prohibited.

In the case of DERS, copies of selected signaling messages can be transmitted to the connection controller, so that a connection controller can also in the case of this variant have knowledge of the existing connections between the terminals. However, these connections are not actively influenced or verified by the controller itself.

In short, the split function between the two planes can be described in such a way that only the functions required to transmit the useful information are assigned to the resource control plane while the intelligence for controlling the resource control plane is included in the connection control plane. In other words the devices of the resource control plane the least possible network control intelligence and can as a result be implemented particularly economically and advantageously on the separate hardware platforms. This is of particular advantage because of the higher installation numbers in this plane compared to the connection control plane.

The integration of these different networks results in hybrid networks in which different protocols are used. In order that all the devices can communicate unrestrictedly with one another in a network of this kind (e.g. IP-based telephone compatible with PSTN and vice versa), an interworking between the specific protocols is required (e.g. SIP and H.323 in packet-oriented multimedia networks or ISUP and DSS1 in line-oriented PSTN networks). This interworking must be widely displaced and besides the pure interworking of the bearer also includes the interworking of performance parameters or services such as call hold, call waiting, call redirect, etc.

The interworking between two different protocols can be brought about indirectly or directly. In the case of indirectly interworking an additional, third protocol is switched between the two protocols—e.g. the protocol BICC (bearer independent call control) according to the standard Q.1902 or the protocol SIP_T (SIP for telephones) which is described in the standard RFC3372. On the other hand, the direct interworking takes place directly between the two different protocols, i.e. without using an intermediate protocol.

In both convergent multimedia networks and hybrid networks that are formed for example by integrating a convergent multimedia network with a conventional line-oriented voice network, new technical problem settings result with the transmission of information, particularly information in real-time packet flows, due to the new and/or different technologies which are used in the respective network types.

The object of the invention is to identify at least one of these problems and to specify at least one solution to enrich the prior art.

The invention is based on the fact that the CCRS technology in terminals of multimedia networks is considerably easier to configure than that of the DERS technology. In the case of CCRS, only the address of a connection controller must be entered in a terminal. This address is generally already known time of the initial installation. On the other hand, in the case of DERS it must be ensured that the address of each terminal for which a connection controlled per DERS should be set up, exists in the terminal. This may be realized in very small homogeneous local area networks (LAN). However, this poses a considerable problem in larger wide area networks (WAN) because of the large number of terminals that are connected to networks of this type.

Furthermore, the invention is supported by the fact that during the evolution of hybrid networks which resulted due to the integration of proved line-oriented networks with modern multimedia networks, many of the long standing features established in the line-oriented networks are not supported or are at least only partially supported. One reason behind this is the large number of new interworking interfaces and protocols whereby the previous features are not yet supported or not completely supported.

However, a particular problem arises for multimedia video telephony because of the accompanying combined transmission of voice and image information which, according to prevailing opinion, must be transmitted with one another and particularly in the same network type.

On the one hand, from the point of view of the invention, multimedia networks are more suitable for the transmission of image information. If the voice information is transmitted completely in multimedia networks, then at least a part of the previous PSTN features is lost (e.g. no telephone in PSTN, no call waiting, no call redirect, no intelligent network services).

On the other hand, the voice information could be transmitted to the previous line-oriented networks, but then the image information should also be transmitted to these networks. However, these networks are poorly developed for the transmission of image information (e.g. does not match the conventionally fluctuating transmission rate of image information with its fixed allocation of transmission capacities). In addition, its signaling is often not designed to control the combined transmission of voice and image information.

A solution for this problem situation based on the invention is specified in the Claims.

A plurality of advantages is associated with this solution:

By transmitting two different signaling models, the invention is achieved by the idea that voice and image information must always be transmitted with one another. By means of this decoupling, the requirement is made that the transmission of voice information must be controlled by a PSTN-based, feature-prolific signaling and the transmission of image information through a multimedia, flexible signaling.

Controlling the CCRS connection by combining the PSTN protocol BICC and the multimedia protocol H.225 results in the particularly advantageous fact that because of the previously detailed interworking between these two protocols, all the previous PSTN features are also largely available in the H.323 end point.

Further advantageous embodiments of the invention result from the claims.

The object is achieved by giving the address of the partner to a DERS connection using the CCRS whereby this address can be determined in a large WAN from an end point. By regressing to the CCRS, the configuration of the terminal remains simple. Nevertheless complex DERS connections can be set up.

Transmission of the address by means of an indirect protocol only requires one single protocol element. Provided that this protocol element is not found in this protocol, the costs incurred to expand the protocol are advantageously minimized as a result.

The invention is detailed below with reference to further exemplary embodiments also shown in the FIGURE.

### BRIEF DESCRIPTION OF THE DRAWING

The single FIGURE shows an exemplary embodiment of the invention

### DETAILED DESCRIPTION OF INVENTION

The invention is embodied in the FIGURE by an exemplary arrangement for realizing the method according to the invention, said method including several functional units and protocols for its integration. Therefore, two connections are set up between two end points A, B. To control the first connection, the end points A, B are indirectly connected in each case via a connection controller CC_{A}, CC_{B} assigned to them by means of the protocols H.225_{A}, H.225_{B} to the interworking units PCU_{A}, PCU_{B} of a line-oriented network PSTN, between which an expanded protocol BICC* (ADR) is used according to the invention. To control the second connection, the two end points are connected directly via a protocol H.245.

H.225 messages are sent according to the CCRS technology from the end points A, B, to the address ADR_{CCA}, ADR_{CCB} of its respective connection controller CC_{A}, CC_{B} and H.245 messages are sent according to the DERS technologies to the address ADR_{A}, ADR_{B} of its opposite end points A, B in each case.

The interworking units PCU are either allocated to separate media gateway controller devices MGC_{A}, MGC_{B} (connected via a signaling network SS7) or to a common controller unit MGC (connected via a controller core CFS) and as a part of a line-oriented network PSTN. All the other functional units are assigned at least to one packet-oriented network IP. Therefore it is then apparent to the relevant expert that the invention can obviously be used in any packet-oriented networks such as the intranet, the extranet, a local network (local area network—LAN) or a corporate network for example embodied as a virtual private network (VPN).

Emphasis has been placed on the fact that the embodiments of the invention shown in this manner, must despite their partially highly detailed representation of specific network scenarios, only be understood to be of an exemplary nature and not in a restricting way. It is clear to the expert that the invention functions for all the possible network configurations, particularly other interworking scenarios. In particular, the H.323 protocol can be replaced with the SIP protocol and the protocol BICC* with the protocol SIP_T or other protocols having the same influence.

An exemplary embodiment of the invention is explained below whereby the interworking units PCU are assigned to a common controller device MGC and interconnected to a controller core CFS. In this embodiment, the individual functional units produce the following (thus x ε {A, B} applies to the index x in each case):

Terminals A, B: Terminating the H.225 signaling, the exchange of which in the CCRS mode the address ADR_{CCx} of the assigned connection controller CCₓ is used and terminating the H.245 signaling for the exchange of which in the DERS mode, the address ADRₓ of said terminal A, B is used to which the information should be transmitted.

Connection controller CCₓ: From this, the H.225 signaling is essentially routed between the terminals A, B and the interworking units PCUₓ.

Interworking unit PCUₓ: Here the H.225 signaling of the terminals A, B is converted and redirected to the protocol BICC*.

Controller core CFS: Here the classical call processing functions for implementing the reliable line-oriented features or services are realized.

To transmit voice and image information that is required for implementing the video telephony, the terminals A, B have the possibility after a concluded setup of a first connection, that is controlled by using the protocol H.225 in the CCRS mode—i.e. by switching via the connection controller CC—to set up a second connection, controlled by means of the protocol H.245, to transmit voice information.

According to the conventional prior art, the H.245 signaling between the assigned end points of the H.225 signaling required for transmitting the image information would then also have to be set up and exchanged, therefore between the terminals A, B and the PCU_{X} assigned in each case. According to the invention, a deviation from this standard sequence takes place and instead the H.245 signaling is exchanged directly between the terminals A, B in the DERS mode, i.e. by bypassing the connection controller CC and the controller devices MGC.

According to a preferred embodiment of the invention, the relevant information about the H.245 address ADRₓ is transmitted between the terminals A, B by using the H.225 signaling of the first connection.

For example, in the protocol BICC* a corresponding protocol element, e.g. a parameter for transmitting the address ADR is provided and the interworking unit PCU supports a mapping of this protocol element onto the protocol H.225. On the other hand, in the connection controllers CC and the controller core CFS or the signaling network SS7, no special functionality must be implemented. This has the advantage that with comparatively minor expansions of the software P, only one single module PCU video telephony between the H.323 terminals is possible without the existing line-oriented features of the network PSTN being limited in any way. Particularly the network transitions to the network PSTN, to VoDSL (voice over DSL) or SIP connections are possible in the same way as before.

With that, the terminals A, B make it possible (after the setup of a voice connection switched through the connection controller CC and the controller device MGC) to additionally switch further video channels and in this way to implement multimedia video telephony without having to abandon the previous services.

It is clear to the expert that the invention functions for all the possible network configurations, particularly all the interworking scenarios such as TDM [symbol] IP or TDM [symbol] access gateway. Furthermore, it is clear to the expert that the invention in the case of bi-directional connections can naturally be used in both transmission directions.

In conclusion, reference is made to the fact that the description of the components of the communication network relevant to the invention must basically not be understood as restrictive. For a relevant expert it is particularly apparent that terms such as application, client, server, gateway, controller, etc. must be understood as functional and not physical. In particular all the functional units can be distributed partially or completely in software/computer program products P and/or via several physical devices.

1-10. (cancelled)

11. A method for transmitting information between at least two endpoints of at least one communication network, comprising:
setting up at least a first connection between the endpoints, wherein the first connection is controlled via a Connection Controller Routed Signaling;
setting up at least a second connection between the endpoints, wherein the second connection is controlled by a Direct Endpoint Routed Signaling; and
transmitting the information along the first and/or the second connection.

12. A method according to claim 11, wherein voice information is transmitted along the first connection.

13. A method according to claim 11, wherein voice information is transmitted along the second connection.

14. A method according to claim 12, wherein voice information is transmitted along the second connection.

15. A method according to claim 11, wherein the first connection is set up before the second connection.

16. A method according to claim 12, wherein the first connection is set up before the second connection.

17. A method according to claim 13, wherein the first connection is set up before the second connection.

18. A method according to claim 11, wherein an address of the other endpoint required for setting up the second connection is communicated to one of the two endpoints by using the Connection Controller Routed Signaling of the first connection.

19. A method according to claim 18, wherein the communication is originating from the other endpoint.

20. A method according to claim 12, wherein one address of the other endpoint required for setting up the second connection is communicated to one of the two endpoints by using the connection controller routed signaling of the first connection.

21. A method according to claim 13, wherein one address of the other endpoint required for setting up the second connection is communicated to one of the two endpoints by using the connection controller routed signaling of the first connection.

22. A method according to claim 15, wherein one address of the other endpoint required for setting up the second connection is communicated to one of the two endpoints by using the connection controller routed signaling of the first connection.

23. A method according to claim 22, wherein the address is at least partially transmitted according to a protocol that is not supported by either of the two endpoints.

24. A method according to claim 23, wherein in this protocol, a special protocol, element for transmitting the address is provided.

25. A method according to claim 11, wherein the method is performed by a computer program product by at least one processor unit.

26. A device comprising a mechanism for performing a method for transmitting information between at least two endpoints of at least one communication network, the method comprising:
setting up at least a first connection between the endpoints, wherein the first connection is controlled via a Connection Controller Routed Signaling;
setting up at least a second connection between the endpoints, wherein the second connection is controlled by a Direct Endpoint Routed Signaling; and
transmitting the information along the first and/or the second connection.

27. The device according claim 26, wherein the device is a controller device or an endpoint of an information transmission.

28. An arrangement comprising mechanisms for performing a method for transmitting information between at least two endpoints of at least one communication network, the method comprising:
setting up at least a first connection between the endpoints, wherein the first connection is controlled via a Connection Controller Routed Signaling;
setting up at least a second connection between the endpoints, wherein the second connection is controlled by a Direct Endpoint Routed Signaling; and
transmitting the information along the first and/or the second connection.

29. The arrangement according claim 28, wherein the arrangement is a packet-oriented network, a integrated multimedia network or a hybrid network.
